(19) United States
(12) Patent Application Publication
(10) Pub. No.: US 2004/0075699 A1
(43) Pub. Date: Apr. 22, 2004

(54) Method and apparatus for highlighting graphical objects

(75) Inventors: Alain Franchi, Vancouver (CA); Lawrence Croft, Burnaby (CA)

Correspondence Address: OYEN, WIGGS, GREEN & MUTALA, 480 - THE STATION, 601 WEST CORDOVA STREET, VANCOUVER, BC, V6B 1G1, CA

(73) Assignee: Creo Inc., Burnaby (CA)

(21) Appl. No.: 10/677,332

(22) Filed: Oct. 3, 2003

Related U.S. Application Data
(60) Provisional application No. 60/416,494, filed on Oct. 4, 2002.

(51) Int. Cl. G09G 5/00

(52) U.S. Cl. 345/860

(57) ABSTRACT

Methods and apparatus are provided for highlighting one or more selected objects in a raster image. A rasterizer renders base graphics data containing a plurality of graphic objects to produce a base graphic raster. When a user selects object(s), selection graphic data is generated. The selection graphic data includes a selected graphic object corresponding to the object(s) to be highlighted in the base graphic data. The rasterizer renders the selection graphics data to yield a selection graphic raster. The selection graphic raster and the base graphic raster are composited to yield a graphic raster for display wherein the selected object(s) are highlighted.

### CROSS REFERENCE TO RELATED APPLICATION

The application claims the benefit of the filing date of U.S. application No. 60/416,494 filed on Oct. 4, 2002 and entitled METHOD FOR DISPLAYING SELECTED OR HIGHLIGHTED OBJECTS USING RASTER COMPOSITING, which is hereby incorporated herein by reference.

### TECHNICAL FIELD

The invention relates to the field of displaying graphic data and, in particular, to highlighting selected graphic objects on a display.

### BACKGROUND

Computer applications which permit users to work with graphic objects (“graphics applications”) are widely used in various fields. One field where such applications are common is the graphic arts industry.

Graphics applications typically include a graphical user interface capable of displaying a number of graphical objects. The interface allows a user to select one or more of the objects to be the subject of the user's focus. The application may provide operations which may be applied to selected objects. For example, the application may permit selected objects to be moved, copied or deleted or permit properties of selected objects to be altered. The operations may be specified by any suitable user input including menu inputs, inputs from a pointing device such as a mouse, keyboard inputs, voice inputs, or the like.

Selected objects are typically highlighted on the display so that the user can distinguish the selected objects from other, non-selected objects. Highlighting a selected object involves changing the appearance of the selected object in a manner which indicates to the user that the object has been selected. An example of an application in which it is desirable to highlight selected objects which are among closely adjacent non-selected objects is an application for configuring trapping objects for use in printing. Trapping objects are typically relatively small shapes, which are arranged along boundaries between different colored objects in multi-colored graphic data to be printed. Trapping objects may be placed along color boundaries to minimize the visual effect of any imperfections in the registration of the different colors which are used to print the graphic data. Sophisticated software applications for preparing graphic data for printing allow users to manipulate trapping objects and other objects contained within graphic data.

A graphical user interface may display graphic data comprising a number of different graphic objects. In most graphic applications, individual graphic objects are represented internally in a raster format, a vector format, or some combination of raster and vector formats. A raster format specifies color and other properties of an object on a pixel-by-pixel basis. A vector format defines an object using mathematical constructs.

Since most display and printing devices are raster-based, graphic applications typically include a rasterizer. A rasterizer is typically a system of hardware and/or software that receives the internal representations of the graphic objects to be displayed and produces raster or bit-map data suitable for display and/or printing. The raster data includes raster representations of each of the graphic objects. The process of producing raster data from a number of graphic objects (i.e. the process performed by a rasterizer) is sometimes called “rendering”.

Raster and vector formats each have advantages and disadvantages. Objects in a vector format are easily identifiable and can be readily highlighted. A vector object does not have an inherent resolution and can be displayed in the highest resolution available. However, vector formats require computation time to be rendered into raster data suitable for display and/or printing.

Raster formats are readily and quickly displayed on computer displays (this is especially true when the resolution of the raster data matches that of the computer display on which the raster data will be displayed). However, highlighting a specific object represented in raster format for display presents a significant and complex challenge. For example, highlighting a circle within rasterized data requires identifying the pixels within the raster data which correspond to the circle and changing the visual appearance of some or all of those pixels to highlight the circle.

In cases where it is sufficient to highlight an object by identifying the general location of the object, a basic visual cue that an object is highlighted may be provided by displaying a rectangular shape (i.e. a bounding box) that surrounds the object. This simplistic approach may be inadequate when there is a need to distinguish between objects which are small, closely spaced and/or overlapping. At high zoom levels, the bounding box may fall partially or entirely outside of the field of view presented on the display. If the bounding box is outside of the field of view of the display, then a user may be incapable of determining (from the display) whether a particular object is highlighted.

In other cases it may be necessary to redraw the raster data on the display, so that highlighted objects are displayed with different visual cues that visually identify the objects as being highlighted. This task can be computationally intensive. To avoid display flicker while redrawing the display, current graphics applications use double buffering techniques.

Double buffering is performed with two memory buffers, both of which are associated with the same display. The contents of one of the buffers can be displayed while the contents of the second buffer are being manipulated. While one buffer is displayed, a computer application can manipulate the data in the second, hidden buffer to appropriately indicate highlighted objects. Once the second buffer has been populated, the graphics application causes the contents of the second buffer to be displayed, so as to show the highlighted objects. Switching between display buffers can reduce flickering. In some cases, double buffering can require more display memory than might be desired.

From the foregoing, it can be seen that current techniques for highlighting objects have various deficiencies. These deficiencies are most severe in cases where graphic data to be displayed includes a large number of graphical objects. There is a need for improved methods and apparatus for highlighting objects on a display.

### SUMMARY OF THE INVENTION

This invention provides methods, systems and apparatus for highlighting selected objects on computer displays. One aspect of the invention provides a method for highlighting a selected object on a display. The method comprises rasterizing base graphic data comprising at least one graphic object including a selected graphic object to be highlighted to provide a base graphic raster; providing selection graphic data including a graphic object corresponding to the object to be highlighted; rasterizing the selection graphic data to yield a selection graphic raster; and, compositing the base graphic raster and the selection graphic raster to yield an output graphic raster for display.

In some embodiments of the invention the selection graphic data is provided by copying selected graphic objects from the base graphic data. The copied objects may be simplified before the selection graphic data is rasterized. Simplification of the copied objects may involve replacing the copied objects with simpler objects having the same boundaries as the copied objects.

In specific embodiments of the invention, compositing the selection graphic raster and the base graphic raster involves one or more of setting areas of the output graphic raster corresponding to exposed areas of selected objects to certain highlighting colors, patterning the areas of the output graphic raster, or applying a function to invert or otherwise alter colors of the areas of the output graphic raster.

Another aspect of the invention provides a system for highlighting a selected object on a display. The system comprises a data processing system executing instructions which cause the data processing system to: rasterize base graphic data to provide a base graphic raster, the base graphic raster comprising at least one graphic object including a selected graphic object to be highlighted; provide selection graphic data including a graphic object corresponding to the object to be highlighted; rasterize the selection graphic data to yield a selection graphic raster; and, composite the base graphic raster and the selection graphic raster to yield an output graphic raster for display.

A further aspect of the invention provides apparatus for displaying a raster image with areas corresponding to selected objects highlighted, the apparatus comprises: a user interface configured to permit selection of one or more objects of base graphic data comprising a plurality of graphic objects; means for producing a selection graphic data wherein selected objects are represented by a highlighting attribute; a rendering engine configured to rasterize the base graphic data to yield a base graphic raster and configured to rasterize the selection graphic data to yield a selection graphic raster; and, a compositing engine configured to composite the base graphic raster and the selection graphic raster to yield a graphic raster for display.

The invention may also be embodied in a computer-readable medium carrying instructions which, when executed by a data processing system cause the data processing system to execute a method according to the invention.

Further aspects of the invention and features of specific embodiments of the invention are described below.

### BRIEF DESCRIPTION OF THE DRAWINGS

In drawings which illustrate non-limiting embodiments of the invention:

FIG. 1 is a block diagram illustrating a flow of information in a basic embodiment of the invention;

FIG. 2 is a block diagram schematically illustrating an example of compositing a base graphic raster and a selection graphic raster;

FIG. 3 is a flow chart which depicts an example routine for highlighting selected graphic object(s) on a display in accordance with a particular embodiment of the invention;

FIG. 4 is a schematic depiction of a more detailed implementation of apparatus for highlighting selected graphic object(s) on a display according to a particular embodiment of the invention;

FIG. 5 is a block diagram schematically illustrating an example of compositing a base graphic raster and a selection graphic raster wherein different highlighting techniques are used for different types of graphic objects; and

FIG. 6 is a block diagram schematically illustrating a number of examples of generating selection graphic data where it is desired to highlight the exposed portion of a selected object.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This invention provides methods for highlighting one or more selected objects on a display. A rasterizer renders base graphic data containing one or more graphic objects to produce a base graphic raster. When a user selects object(s), selection graphic data is generated. The selection graphic data includes at least one or more selected graphic objects corresponding to the object(s) to be highlighted on the display. The rasterizer renders the selection graphic data to yield a selection graphic raster. The selection graphic raster and the base graphic raster are composited to yield a graphic raster for display wherein the selected object(s) are highlighted.

“Graphic object” is a broad term used by software engineers to describe elements of a file or stream which can yield an image capable of being displayed. A graphic object may consist of graphic data alone, functions, routines or procedures for generating or manipulating data or a combination of data and functions. Graphic objects may reside in data buffers, signals, or may be recorded in computer-readable media of any type. In some embodiments, of the invention, graphic objects are portions of a set of commands which define a set of one or more images in a description language such as a graphic description language or page description language.

The area of a raster image corresponding to a graphic object may be of any size. For example, a graphic object may yield an image which is as small as a single pixel or up to an arbitrarily large number of pixels. A graphic object may be represented in any suitable format. For example, raster objects may be represented in raster formats, vector formats, or any combinations of raster, vector and bitmap formats. A graphic object may comprise a plurality of other graphic objects. For example, a graphic object may comprise one or more stroke objects, fill objects or boundary objects. Some types of fundamental graphic objects may be referred to as “primitives”. A graphic object may comprise a number of primitives.

In some embodiments of the invention, graphic objects are delineated by tags within a file or a stream of data. The tags may mark the beginnings and ends of graphic objects or otherwise delineate a graphic object from among other graphic objects in a file or stream of data.

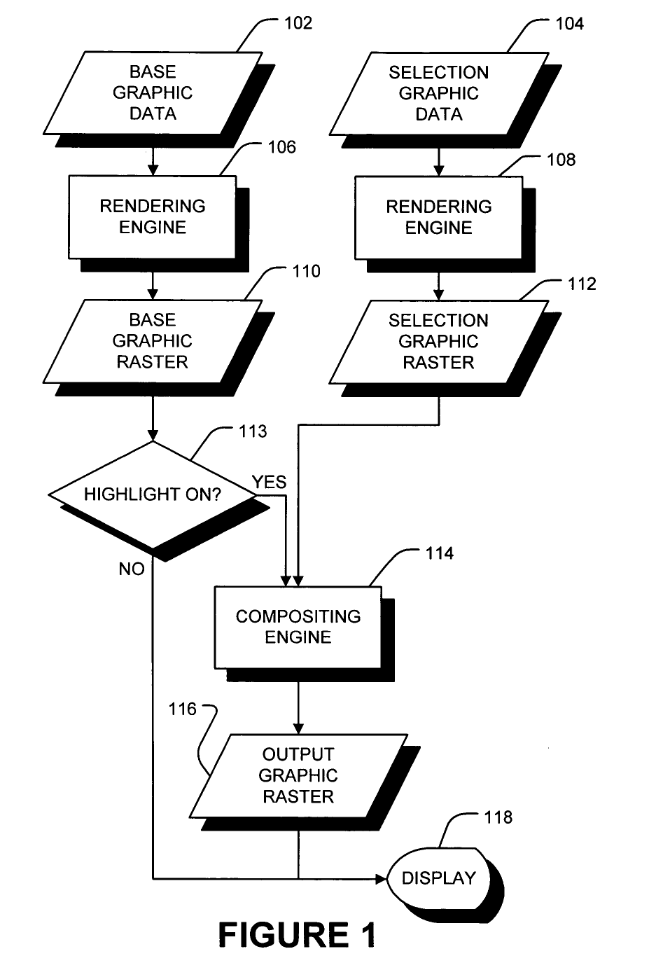

FIG. 1 is a block diagram which illustrates a flow of data in a basic embodiment of the invention. The data flow illustrated in FIG. 1 commences with base graphic data 102. Base graphic data 102 includes one or more graphic objects. For example, base graphic data 102 may be a file containing graphic objects, a stream of data containing graphic objects and/or a data buffer containing graphic objects. Base graphic data 102 may be provided in the form of a set of statements in a graphic description language, a document markup language or a portable document format (e.g. ADOBE™ PDF format), for example.

Base graphic data 102 is sent to a rendering engine (i.e. a rasterizer) in block 106, where it is converted into base graphic raster 110. If none of the object(s) in base graphic data 102 is to be highlighted (as determined at block 113), then base graphic raster 110 is displayed on a display 118. If one or more objects in base graphic data 102 are to be highlighted, then selection graphic data 104 corresponding to the selected objects is generated and sent to a rendering engine in block 108, where it is converted to selection graphic raster 112. The same rendering engine may be used in both of blocks 106 and 108.

Selection graphic data 104 identifies one or more selected graphic objects to be highlighted by means of one or more visual selection cues. The visual selection cue(s) used for highlighting may include, for example, one or more colors, patterns, color changes (such as color substitutions or inversions), intensities, temporal flashing patterns, animations, or other visual characteristics which may be applied to all or parts of selected objects. Selection graphic data 104 may generally comprise any form of data capable of representing one or more graphic objects. In some embodiments, selection graphic data 104 is in the same format as base graphic data 102.

When selected object(s) are to be highlighted (i.e. displayed with visual selection cues) base graphic raster 110 and selection graphic raster 112 are composited by a compositing engine 114 to yield graphic raster 116 for display on display 118.

Compositing engine 114 receives base graphic raster 110 as a first input and selection graphic raster 112 as a second input and produces output graphic raster 116. Output graphic raster 116 constitutes a modified version of base graphic raster 110. When output graphic raster 116 is displayed, the object(s) selected by the user are highlighted. A graphic application can turn highlighting on by causing output graphic raster 116 to be displayed and can turn highlighting off by causing base graphic raster 110 to be displayed.

Compositing engine 114 uses selection graphic raster 112 to identify pixels in base graphic raster 110 which correspond to selected object(s). Compositing engine 114 alters the pixel values of output graphic raster 116 which correspond to selected object(s). The specific nature of the alteration performed by compositing engine 114 may be predetermined, or may be specified by information contained in selection graphic raster 112 or may be determined in accordance with a particular logical highlighting routine based on selection graphic raster 112 and/or base graphic raster 110.

Pixels of base graphic raster 110 have associated values which may be assigned by the rendering engine in block 106. Selection graphic data 104 may be generated in a manner, such that after rendering in block 108, pixels of selection graphic raster 112 which correspond to selected object(s) are assigned certain pixel values, or at least pixel values falling within certain ranges. The pixel values of output graphic raster 116 are determined by compositing engine 114. Preferably, compositing engine 114 generates output graphic raster 116 having pixels with the same values as the pixels of base graphic raster 110, except for pixels corresponding to selected object(s). The pixel values of output graphic raster 116 may be a function of one or both of the corresponding pixel values of selection graphic raster 112 and the corresponding pixel values of base graphic raster 110. For example, for pixels corresponding to selected object(s):

compositing engine 114 may generate output graphic raster 116 with pixel values which are the same as the pixel values of selection graphic raster 112;

pixel values of output graphic raster 116 may be determined by a highlighting routine, wherein the pixel values of selection graphic raster 112 determine functions to apply to corresponding pixel values of base graphic raster 110 to produce corresponding pixel values for output graphic raster 116;

the pixel values of output graphic raster 116 may be set to specific values which are mapped to by values of corresponding pixels in selection graphic raster 112; and/or

the pixel values of output graphic raster 116 may be determined by a highlighting routine based on both the pixel values of base graphic raster 110 and the pixel values of selection graphic raster 112.

In some embodiments of the invention, highlighting can be turned on or off on display 118 by selecting between, base graphic raster 110 and output graphic raster 116. In such embodiments, base graphic raster 110 is displayed at times when no highlighting is desired and output graphic raster 116 is displayed at times when highlighting is desired. These embodiments may comprise double-buffering techniques. In these double-buffering embodiments of the invention, highlighting can be turned on or off almost instantaneously.

In other embodiments of the invention compositing is performed in such a manner that the highlighting can be turned off by re-compositing output graphic raster 116 with selection graphic raster 112. For example, if the compositing engine is configured to invert color values of selected objects, then re-compositing output graphic raster 116 with selection graphic raster 112 will invert the color values of the selected objects a second time and thereby restore the color values of the selected objects to their original values (i.e. the values of base graphic raster 110). Compositing/re-compositing may be relatively fast in comparison to rasterizing graphic data. Re-compositing output graphic raster 116 with selection graphic raster 112 can be performed repeatedly to flash the highlighting of selected objects on and off. The highlighting can be flashed on and off at a constant rate. The maximum rate may be dependent upon processing resources, such as the sizes of buffers holding selection graphic raster 112 and output graphic raster 116.

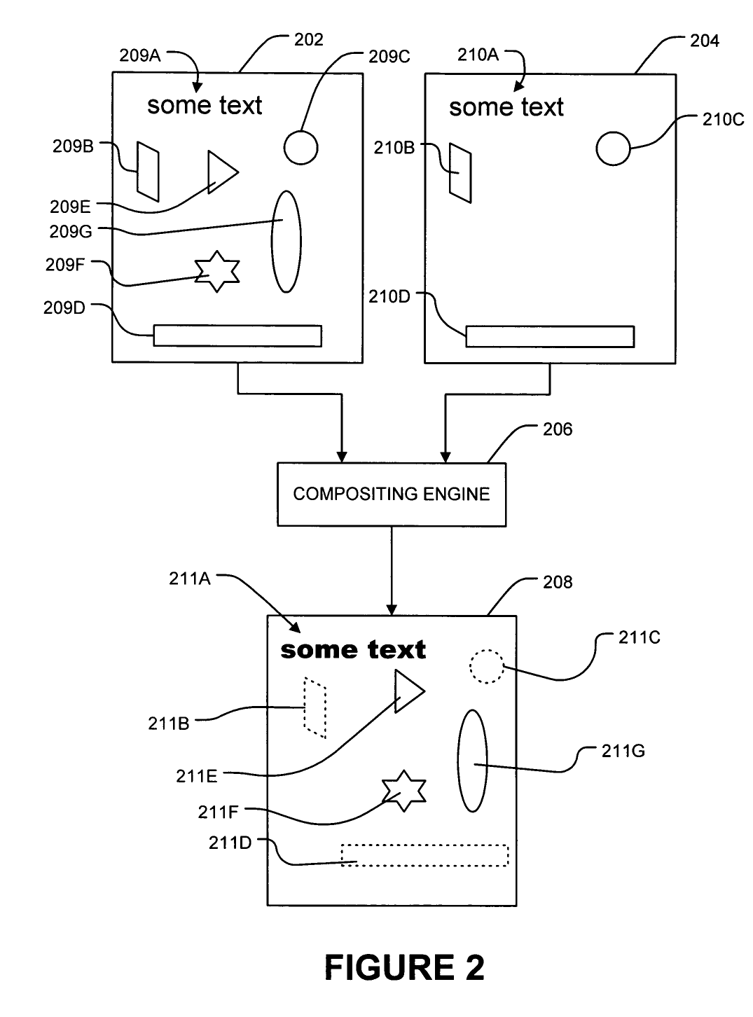

FIG. 2 is a block diagram which schematically illustrates a base graphic raster 202, a selection graphic raster 204, and an output graphic raster 208. Output graphic raster 208 represents the compositing of base graphic raster 202 and selection graphic raster 204. Base graphic raster 202, selection graphic raster 204 and output graphic raster 208 may be stored in memory buffers for example. In FIG. 2, base graphic raster 202 and selection graphic raster 204 have already been rendered by a suitable rendering engine.

Base graphic raster 202 comprises a number of graphic objects 209. In the illustrated embodiment, graphic objects 209 are represented by text 209A, parallelogram 209B, circle 209C, rectangle 209D, triangle 209E, star 209F and ellipse 209G. Selection graphic raster 204 comprises a number of selected graphic objects 210. In the illustrated embodiment, a user has selected text 209A, parallelogram 209B, circle 209C and rectangle 209D for highlighting. Accordingly, the selected graphic objects 210 in selection graphic raster 204 include text 210A, parallelogram 210B, circle 210C and rectangle 210D.

Data from base graphic raster 202 and selection graphic raster 204 are directed to compositing engine 206. Compositing engine 206 generates output graphic raster 208, which is displayed on a display (not shown). As shown in FIG. 2, compositing engine 206 creates output graphic raster 208 such that the pixel values for selected objects 211A, 211B, 211C, 211D are modified in output graphic raster 208. When output graphic raster 208 is displayed, selected objects 211A, 211B, 211C, 211D are highlighted. Compositing engine 206 creates output graphic raster 208 such that the pixel values for non-selected objects 211E, 211F, 211G are the same as those of objects 209E, 209F, 209G from base graphic raster 202.

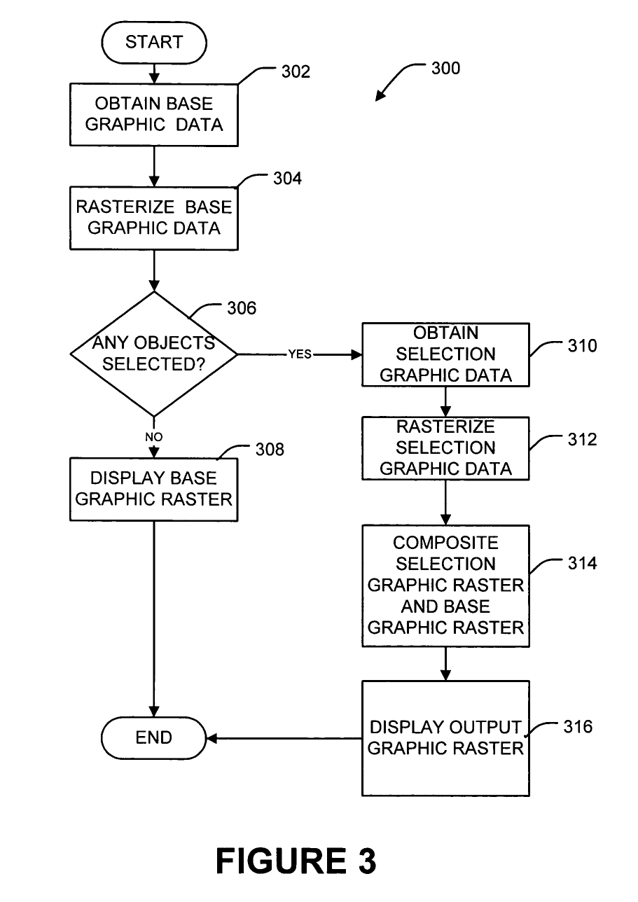

FIG. 3 is a flow chart diagram illustrating an example routine 300 for highlighting selected object(s) on a display in accordance with a particular embodiment of the invention. Base graphic data is obtained in block 302. The base graphic data obtained in block 302 comprises at least one, and typically a plurality of, graphic object(s). At block 304, the base graphic data is rasterized according to the requirements for the display on which the graphic data will be displayed. Rasterizing may be done using any suitable rendering engine which may comprise hardware, software or some combination thereof. The output of the rasterizing process of block 304 is a base graphic raster, which is a rasterized version of the base graphic data obtained in block 302.

Block 306 involves a query as to whether any graphic object(s) within the base graphic data have been selected by a user for highlighting. If there are no object(s) to be highlighted, then the base graphic raster generated in block 304 is displayed on the computer display at block 308. If it is determined in block 306 that one or more object(s) within the base graphic data are to be highlighted, then selection graphic data is obtained in block 310. The selection graphic data obtained in block 310 may be generated using any of a number of different techniques which are explained in further detail below. In one possible embodiment, obtaining selection graphic data in block 310 comprises copying selected object(s) from the base graphic data into the selection graphic data. The selection graphic data obtained in block 310 is rasterized in block 312 to generate a selection graphic raster. The selection graphic data may be rasterized in using the same rendering engine used to rasterize the base graphic data in block 304.

In block 314, the base graphic raster (generated in block 304) is composited with the selection graphic raster (generated in block 312) to produce an output graphic raster. As part of the compositing process of block 314, the pixels of the output graphic raster which are associated with selected object(s) are modified such that the selected object(s) appear highlighted when displayed. In one possible embodiment, the compositing process of block 314 comprises copying the pixel values from the base graphic raster, using the selection graphic raster to determine which pixels of the base graphic raster correspond to selected object(s), and then modifying the pixel values of the output graphic raster for these pixels, such that the selected object(s) will appear highlighted when displayed. In other possible embodiments, the compositing process of block 314 comprises a pixel by pixel (or bit by bit) function of the base graphic raster and the selection graphic raster to determine whether the corresponding pixel (or bit) of the output graphic raster corresponds to a selected object and should therefore be modified to display highlighting.

In block 316, the output graphic raster is displayed on a display. Displaying the output graphic raster on the display may comprise copying the output graphic raster into a buffer of a display adapter, for example. Where one or more object(s) have been selected by a user, these object(s) will appear highlighted when the output graphic raster is displayed in block 316. The highlighting occurs because pixel values associated with the selected object(s) within the output graphic raster are modified during the compositing process of block 314. As discussed above, different visual cues may be used for highlighting. In some alternative embodiments of the invention, the base graphic raster (generated in block 304) is displayed first and then the base graphic raster and the selection graphic raster are subsequently composited directly into a display buffer such that selected object(s) are highlighted.

The highlighting techniques described above and depicted in FIGS. 1-3 involve applying highlighting during the compositing process (i.e. after rendering the base graphic data to obtain a base graphic raster and after rendering the selection graphic data to obtain a selection graphic raster). As such, these highlighting techniques are capable of providing resolution independent highlighting. For example, when a user zooms in on particular features of a displayed image, the base graphic data and selection graphic data are re-rendered at a higher resolution. The re-rendered base graphic raster and selection graphic raster are then composited to produce a new output graphic raster at the higher resolution. Any highlighting applied to the output graphic raster during compositing will also have the higher resolution. This is particularly significant when the highlighting has the form of a pattern applied to parts of the image corresponding to selected objects.

The highlighting techniques of FIGS. 1-3 are also well suited for circumstances where a user is frequently zooming and/or panning a displayed image. When a user pans a displayed image or zooms in or out on a displayed image without changing the object(s) that are selected, the process of obtaining selection graphic data (i.e. block 310 in FIG. 3) need only be performed once.

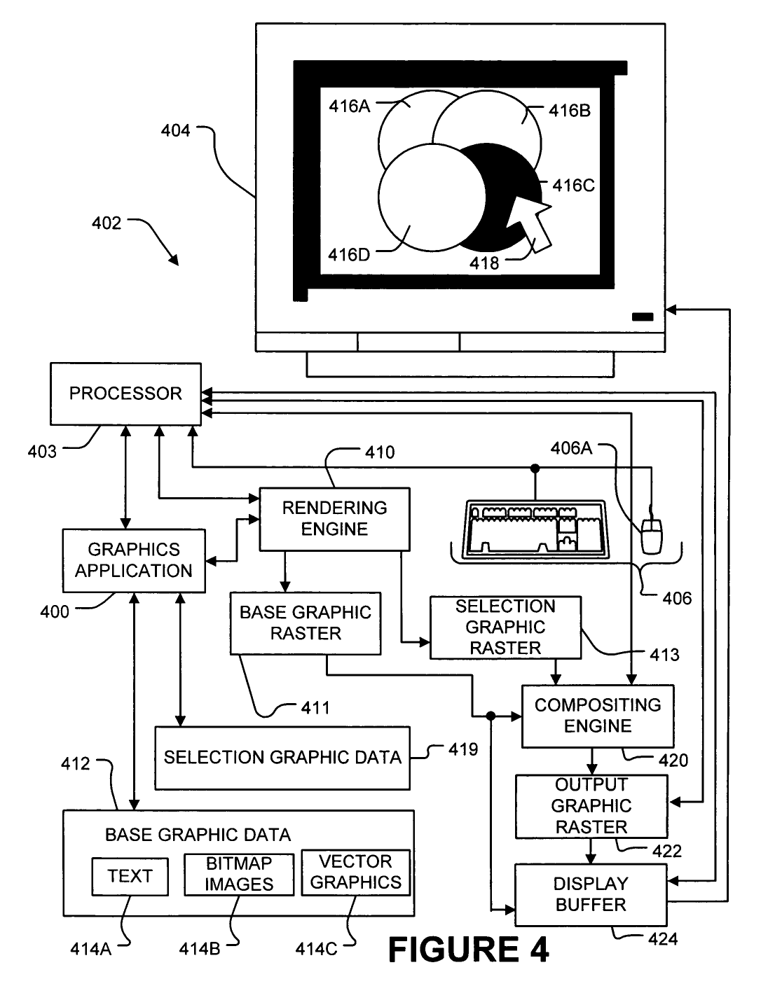

A more detailed implementation of the invention will now be described with reference to FIG. 4. As shown in FIG. 4, a computer graphic application 400 is running in a computer 402 which includes a data processor 403. Computer 402 has a display 404 and one or more user input devices 406. Graphic application 400 has access to a rendering engine 410. Rendering engine 410 may comprise hardware, software or a combination of hardware and software which receives data representing graphic objects to be shown on display 404 and produces a corresponding graphic raster suitable for displaying on display 404.

Application 400 permits a user to interact with base graphic data 412. Base graphic data 412 could, for example, include graphics stored in a suitable form for printing a print job. Base graphic data 412 may include various categories or formats of graphic objects, such as text 414A, bitmap images 414B, and vector graphics 414C, for example. Base graphic data 412 may contain, any practical number of different graphic objects.

When a user causes application 400 to open or otherwise display base graphic data 412, application 400 passes base graphic data 412 to rendering engine 410. Rendering engine 410 produces a base graphic raster 411 which includes a rasterized representation of the objects in base graphic raster 412. Processor 403 may cause base graphic raster 411 to be displayed on display 404 by sending base graphic raster 411 to display buffer 424. In the apparatus of FIG. 4, any rasterized data received in display buffer 424 is displayed on display 404. In the illustrated example, display 404 shows an image comprising circles 416A, 416B, 416C, 416D. A cursor 418 controlled by a pointing device 406A may also be displayed on display 404.

A user may select one or more objects by way of a user interface provided by computer 402. For example, the user may direct pointing device 406A to place cursor 418 over the display of an object to be selected and click a button to select the object. Application 400 may determine which object the user wishes to select from the coordinates of cursor 418 at the time the button is clicked. In the illustration of FIG. 4, the user has selected circle 416C, which appears highlighted on display 404.

Upon selection of one or more objects, application 400 generates selection graphic data 419 for use in creating a selection graphic raster 413. In various embodiments of the invention, selection graphic data 419 is generated in different ways. In some embodiments of the invention, selection graphic data 419 is generated by copying selected object(s) from base graphic data 412. Selection graphic data 419 may include various categories or formats of graphic objects, such as text 414A, bitmap images 414B, and vector graphics 414C, for example. Preferably, selection graphic data 419 has the same format as base graphic data 412. For example, selection graphic data 419 and base graphic data 412 may both comprise a similar data structure, such as a file or a stream of data. As a more specific example, selection data 419 and graphic data 412 could both be in ADOBE™ PDF format. In some embodiments, selection graphic data 419 is obtained by creating a blank file having an appropriate format and copying selected objects from base graphic data 412 into the blank file.

Selection graphic data 419 is rasterized by rendering engine 410 to yield a selection graphic raster 413. Compositing engine 420 receives base graphic raster 411 and selection graphic raster 413 and performs a function on this data to generate output graphic raster 422. Output graphic raster 422 is then sent to display buffer 424 for displaying on display 404. When output raster 422 is displayed on display 404, pixels of output graphic raster 422 provide one or more visual cues (i.e. highlighting) which identifies selected object(s).

The highlighting technique described above in relation to FIG. 4 involves applying highlighting during compositing (i.e. after rendering base graphic data 412 to obtain base graphic raster 411 and after rendering selection graphic data 419 to obtain selection graphic raster 413). As such, the highlighting technique of FIG. 4 may provide resolution independent highlighting, as described above with reference to FIGS. 1-3.

The highlighting technique described above in relation to FIG. 4 is also well suited for circumstances where a user is frequently zooming and/or panning a displayed image. Obtaining selection graphic data 419 does not need to be repeated when a user pans a displayed image or zooms in or out on a displayed image as long as the same object(s) remain selected.

Compositing engine 420 uses base graphic raster 411 and selection graphic raster 413 to create output graphic raster 422. Output graphic raster 422 comprises pixel values similar to those of base graphic raster 411, except for in pixels corresponding to selected object(s), where compositing engine 420 modifies the pixel values such that selected object(s) appear highlighted when displayed. Compositing engine 420 uses the pixels of selection graphic raster 413 to determine which pixels correspond to selected object(s). The pixels of selection graphic raster 413 corresponding to selected object(s) are assigned pixel values which may be referred to as “highlighting values”. Pixels of selection graphic raster 413 having highlighting values cause compositing engine 420 to apply highlighting to corresponding pixels in output graphic raster 422 (i.e. compositing engine 420 alters the values of those pixels in output graphic raster 422 which correspond with pixels in selection graphic raster 413 that have highlighting values to be different from the values of the corresponding pixels in base graphic raster 411). The highlighting values of the pixels in selection graphic raster 413 may comprise color values of the pixels. Other pixels of selection graphic raster 413 do not correspond to selected object(s). These pixels of selection graphic raster 413 are assigned pixel values which may be referred to as “non-highlighting values”. Pixels of selection graphic raster 413 having non-highlighting values cause compositing engine 420 to set the values of corresponding pixels in output graphic raster 422 to be the same as the values of the corresponding pixels in base graphic raster 411 (i.e. compositing engine does not modify the values of these pixels in output graphic raster 422).

In general, the function performed by compositing engine 420 to generate output graphic raster 422 may be a function of one or both of the pixel values of selection graphic raster 413 and the pixel values of base graphic raster 411. For example, where all of the pixels of selection graphic raster 413 have non-highlighting values (i.e. the user has not selected any objects that are in the field of view of display 404), output graphic raster 422 may be populated by copying corresponding pixel values from base graphic raster 411. Where any pixels of selection graphic raster 413 have highlighting values, compositing engine 420 performs a highlighting function to generate pixel values for the corresponding pixels of output graphic raster 422. One possible highlighting function involves copying pixel values from base graphic raster 411 into output graphic raster 422 and replacing the corresponding pixel values of output graphic raster 422 with values from any corresponding pixels of selection graphic raster 413 which contain highlighting values. The replacement may be performed during or after the copying. In other embodiments, compositing engine 420 performs a pixel by pixel (or bit by bit) function of base graphic raster 411 and selection graphic raster 413 to determine whether the corresponding pixel (or bit) of output graphic raster 422 corresponds to a selected object and should therefore be modified to display highlighting.

In an additional or alternative highlighting function, the highlighting values of pixels in selection graphic raster 413 determine a particular highlighting technique for compositing engine 420 to use. For example, for pixels in selection graphic raster 413 which have a first highlighting value (or a highlighting value within a first range), compositing engine 420 may apply a certain visual cue (i.e. highlighting technique) to corresponding pixels of output graphic raster 422 and for pixels in selection graphic raster 413 which have a second highlighting value (or a highlighting value within a second range), compositing engine may apply a different visual cue to corresponding pixels of output graphic raster 422, and so on. In a variation of this technique, a highlighting value may comprise, or may be used to identify, a pointer to a particular location in a look up table. The entries of the look up table may be controlled by the user, by processor 403 or by application 400 to specify different highlighting techniques, patterns, colors or the like for compositing engine 420 to apply to corresponding pixels of output graphic raster 422. Such look up tables may be referred to as “index color tables”. In yet another example, compositing engine 420 performs a highlighting routine using the combination of the pixel values of base graphic raster 411 and the highlighting values of the pixels of selection graphic raster 413 to determine a particular way in which to apply highlighting to corresponding pixels of output graphic raster 422.

In general, compositing engine 420 highlights selected object(s) by generating output graphic raster 422 to have different pixel values than those of base graphic raster 411 in pixels of output graphic raster 422 corresponding to selected object(s). These different pixel values in output graphic raster 422 provide one or more visual cues that identify the selected object(s). Such visual cue(s) may include a wide variety of highlighting techniques. For example, compositing engine 420 may cause selected object(s) to be highlighted by one or more of:

Altering the color and/or intensity of all of pixels within the fill area of the selected object(s).

Altering the color and/or intensity of a pattern of pixels within the fill area of the selected object(s). For example, the color of every Nth pixel in every Mth row within such area(s) may have its color value altered. Other patterns may also be provided. In some embodiments of the invention the scale of a highlighting pattern is fixed relative to the display on which the output graphic raster is displayed. In such embodiments, the pattern itself does not change significantly if the user causes the application to zoom in to provide a magnified view of a 11 or part of a selected object.

altering the color and/or intensity values of pixels on a boundary (i.e. stroke area) of a selected object.

altering the color and/or intensity values of some of the pixels (e.g. in a pattern) on the boundary of a selected object.

Altering colors may involve inverting colors, intensifying colors, replacing colors or applying some other function to the colors.

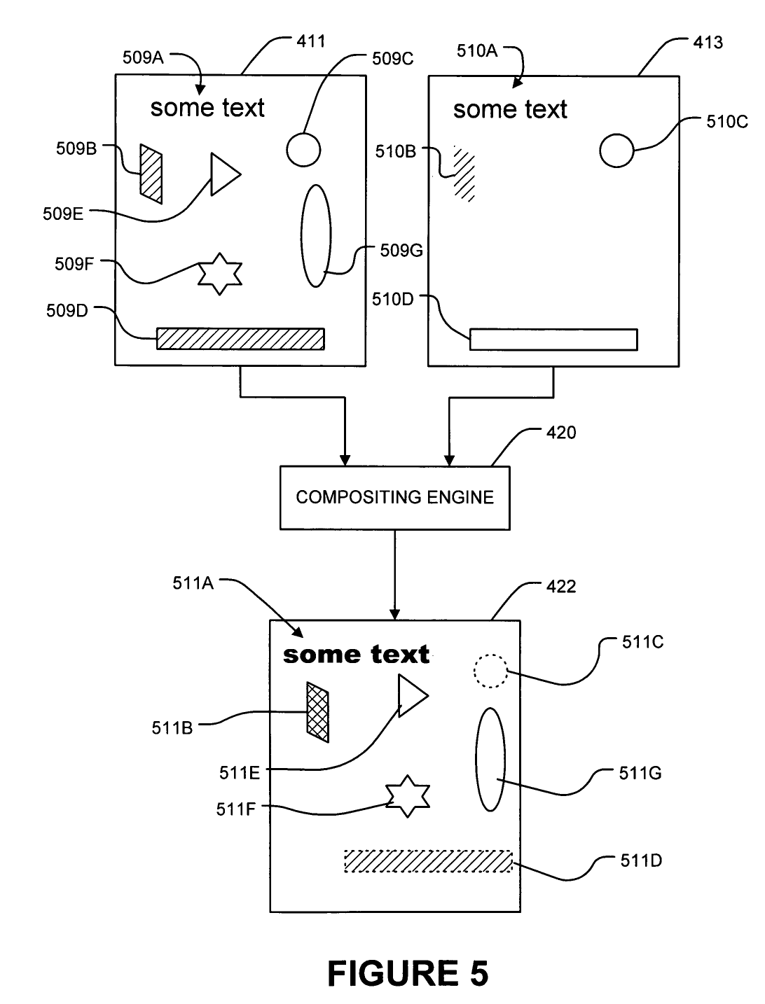

FIG. 5 is a block diagram schematically illustrating an example of compositing base graphic raster 411 and selection graphic raster 413 wherein different highlighting techniques are used for different types of graphic objects. In FIG. 5, base graphic raster 411 is schematically illustrated as comprising a number of graphic objects, which include: text 509A; parallelogram 509B; circle 509C; rectangle 509D; triangle 509E; star 509F; and ellipse 509G. Parallelogram 509B and rectangle 509D comprise both stroke (i.e. boundary) and fill objects, whereas circle 509C, rectangle 509D, triangle 509E, star 509F and ellipse 509G comprise just stroke objects.

In FIG. 5, a user has selected text 509A, the stroke of circle 509C, the stroke of rectangle 509D and the fill of parallelogram 509B for highlighting. Accordingly, in selection graphic raster 413, the pixels associated with text 510A, the stroke of circle 510C, the stroke of rectangle 510D and the fill of parallelogram 510B are assigned highlighting values. Base graphic raster 411 and selection graphic raster 413 are provided as inputs to compositing engine 420 which generates output graphic raster 422.

In output graphic raster 422, the pixels associated with the selected objects are highlighted. Text 511A is highlighted in output graphic raster 422 by bolding the text; the fill of parallelogram 511B is highlighted by applying a pattern of color change to the fill of parallelogram 511B; and the stroke of circle 511C and rectangle 511D are highlighted by applying a pattern of color change to the stroke of circle 511C and rectangle 511D. Triangle 511E, star 511F and ellipse 511G are not selected by the user and therefore do not appear highlighted in output graphic raster 422. Although not shown in FIG. 5, other visual cue(s) (i.e. highlighting technique(s)) could also be used by compositing engine 420 as discussed above.

In some embodiments of the invention, compositing engine 420 uses the highlighting values of the pixels in selection graphic raster 413 to specify a particular highlighting technique (i.e. visual cue) to apply to corresponding pixels of output graphic raster 422. For example, when generating output graphic raster 422, compositing engine 420 may alter the pixel values of output graphic raster 422 from the pixel values of corresponding pixels in base graphic raster 411 in different manners as a function of the highlighting value for the corresponding pixel in selection graphic raster 413.

Base graphic data 412 may contain graphic objects which application 400 treats as being of different types. For example, a trapping application might treat traps and objects which specify other shapes differently. The highlighting value assigned to the pixels of selection graphic raster 413 may depend on the type of graphic object(s) that the user has selected. Thus, different types of graphic objects may be highlighted using different kinds of visual cue.

There is not always a 1:1 correspondence between color attributes specified for objects in base graphic data and pixel colors produced by a rendering engine. A rendering engine may perform functions such as anti-aliasing which result in slight variations in the output colors produced by the rendering engine. To prevent such color shifts from affecting the operation of compositing engine 420 compositing engine 420 may respond in the same manner to any highlighting value within a range of highlighting values.

Table I shows an example of how, when selected, different types of graphic objects may be assigned different highlighting values in selection graphic raster 413. These different highlighting values may then be used by compositing engine 420 to produce output graphic raster 422 in which a different highlighting technique is used for any selected object(s) of each different type. Results similar to those of the technique described above and in Table I (i.e. where different highlighting techniques are used for different types of objects) may be obtained using index color tables.

TABLE I
Example of Using Different Highlighting Values for Different Types
of Objects to Provide Different Highlighting Techniques

| Type of | Highlighting Value in | |
|---|---|---|
| Graphic | Selection Graphic | Action Taken by |
| Object | Raster | Compositing Engine |
| Object Outline | 0-42 | Replace all pixels in |
| | | object with color #1 |
| Object Fill | 43-84 | Replace every Nth pixel |
| | | with color #2 |
| Trap Outline | 85-126 | Replace all pixels in |
| | | object with color #3 |
| Trap Fill | 127-169 | Replace all pixels in |
| | | object with color #3 |
| Group Graphic | 170-212 | Replace all pixels in |
| Object Outline | | object with color #4 |
| Group Graphic | 213-255 | Replace every Mth pixel |
| Object Fill | | with alternative |
| | | high/low intensity tints |
| | | of color #4 |

Selection graphic data 419 may be generated using a number of techniques. In an embodiment discussed above, selection graphic data 419 is generated by copying selected object(s) from base graphic data 412 into selection graphic data 419. Preferably, in addition to copying selected object(s) from base graphic data 412, the generation of selection graphic data 419 involves assigning “highlighting attributes” to the selected object(s) in selection graphic data 419.

As used in this description and the accompanying claims, a “highlighting attribute” is an attribute or characteristic of a graphic object which, when rendered, causes one or more pixels associated with the object to have highlighting values. For example, a highlighting attribute may be assigned to a selected object in selection graphic data 419. When selection graphic data 419 is rasterized by rendering engine 410, one or more pixels of the resulting selection graphic raster 413 that are associated with the selected object will be assigned highlighting values. The highlighting attributes may comprise color attributes and the highlighting values may comprise color values.

The generation of selection graphic data 419 may also comprise assigning “blank attributes” to certain object(s). As used in this description and the accompanying claims, a “blank attribute” is an attribute or characteristic of a graphic object which, when rendered, causes the pixels associated with the object to have non-highlighting values. Typically, objects assigned blank attributes will be non-selected objects. For example, a blank attribute may be assigned to a non-selected object in selection graphic data 419. When selection graphic data 419 is rasterized by rendering engine 410, the pixels of the resulting selection graphic raster 413 that are associated with the non-selected object will be assigned non-highlighting values.

In preferred embodiments of the invention, selection graphic data 419 is generated using simplified version(s) of selected object(s). For example, where a selected object comprises a bitmap image, the details of the bitmap image may not be necessary to the highlighting process. The bitmap image may be represented in selection graphic data 419 by a shape which has a substantially similar boundary to that of the bitmap image. The simplified shape may be assigned a highlighting attribute. Rendering such a representative shape to prepare selection graphic raster 413 may be performed more quickly than rendering the bitmap image, especially where the bitmap image has a different resolution than is required for display 404. A bitmap image which has a resolution different from that desired for display 404 could also be simplified by re-rendering it to have the desired resolution. Complicated vector objects may also be simplified by replacing them in selection graphic data 419 with shapes having boundaries substantially similar to those of selected vector objects.

In some cases, base graphic data 412 will contain some objects which overlap with and hide portions of other objects. For some applications, it may be desirable to highlight only the non-hidden (i.e. exposed or visible) portions of an object. In such cases, it is desirable to create a selection graphic raster 413 where only pixels corresponding to exposed portions of selected object(s) are assigned highlighting values. When only pixels corresponding to exposed portions of selected object(s) are assigned highlighting values in selection graphic raster 413, the resulting output graphic raster 422 produced by compositing engine 420 will only highlight pixels corresponding to exposed portions of selected object(s). Creating a selection graphic raster 413 wherein only pixels corresponding to exposed portions of selected object(s) are assigned highlighting values may be accomplished by generating selection graphic data 419, such that only exposed portions of selected object(s) are assigned highlighting attributes.

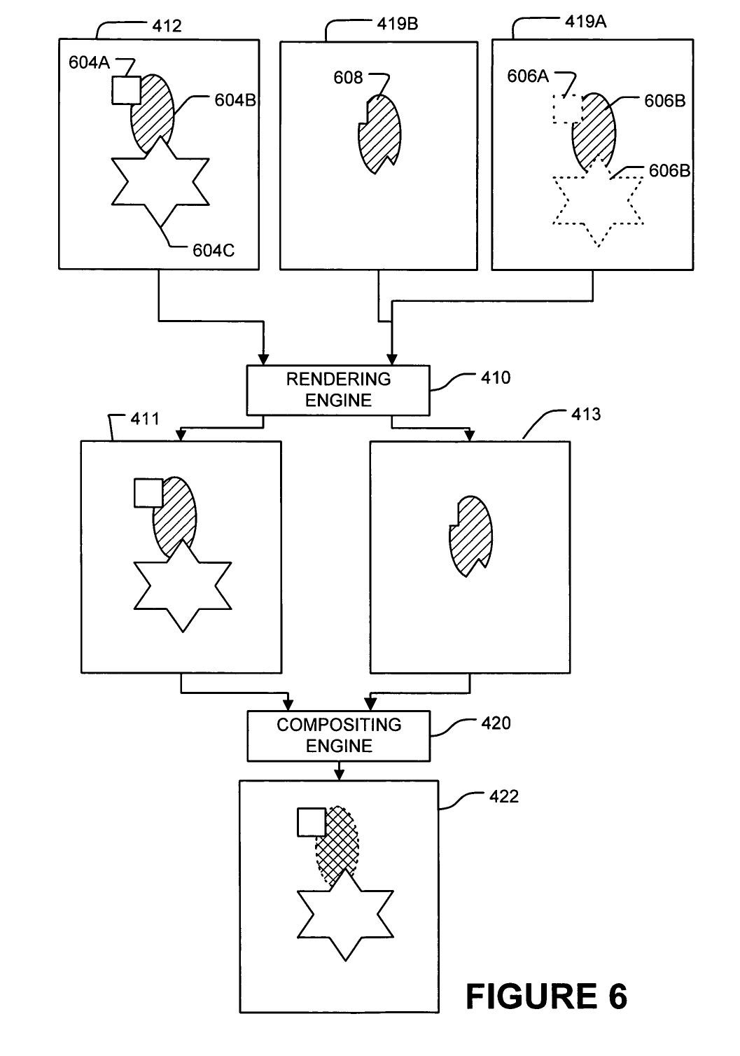

In a particular embodiment of the invention, selection graphic data 419A (see FIG. 6) is generated by copying selected object(s) from base graphic data 412 into selection graphic data 419A and copying at least the non-selected objects which overlap the selected object(s) from base graphic data 412 into selection graphic data 419A. In selection graphic data 419A, the selected object(s) are assigned highlighting attributes and the non-selected objects which overlap the selected object(s) are assigned blank attributes. In areas where the non-selected objects overlap the selected object(s), the highlighting attributes that were assigned to the selected object are replaced with blank attributes.

In the example of FIG. 6, base graphic data 412 includes graphic objects 604A, 604B, and 604C. In the illustrated example, graphic object 604B is selected and objects 604A, 604C are non-selected objects. Non-selected graphic objects 604A and 604C overlap with selected graphic object 604B. Selection graphic raster 419A is created by copying graphic objects 604A, 604B and 604C into selection graphic raster 419A to provide corresponding copied graphic objects 606A, 606B, and 606C. Non-selected overlapping objects 606A and 606B have their highlighting attributes set to blank and selected object 606B is assigned a hightlighting attribute.

Selection graphic data 419A is rasterized by rendering engine 410 to yield selection graphic raster 413 wherein only pixels corresponding to the exposed portion of object 606B have highlighting values.

In some embodiments of the invention, application 400 checks selected objects to determine whether a selection graphic raster can be created without the necessity of including some or all of the non-selected objects in the selection graphic data. If so then application 400 may assemble the selection graphic data in a manner that avoids including objects corresponding to some or all of the non-selected objects in the selection graphic data.

In an alternative embodiment, also illustrated in FIG. 6, the creation of selection graphic raster 413 involves rasterising a selection graphic data 419B which contains one or more newly defined graphic objects 608. The newly defined graphic objects have the shape of exposed portion(s) of a selected object that is overlapped by one or more non-selected objects.

Using this technique, the pixels in selection graphic raster corresponding to any portion of a selected object that is overlapped by non-selected objects will be rendered by rendering engine 410 to have non-highlighting values. The pixels in selection graphic raster 413 will have highlighting values only in regions corresponding to object 608 which correspond, in turn, to exposed portions of selected object(s).

In some cases, other techniques may be used to generate a selection graphic raster in which pixels corresponding to exposed objects, exposed portions of objects and/or boundaries of exposed portions of objects have highlighting values. In some such techniques, selection graphic data 419 can be generated in whole or in part using only exposed objects or exposed portions of objects. For example:

Application 400 may comprise, or otherwise work with, an application, such as some trapping applications, which identifies the boundaries of exposed objects (and boundaries of exposed portions of objects) as part of its operation. These boundaries may be identified in base graphic data 412, in base graphic raster 411 and/or in an internal display list which is directly or indirectly accessible to the application. Information specifying these boundaries may be used to generate new objects which represent the exposed portions of selected objects. Thus, only these new objects, representative of exposed portions of selected objects, need be introduced into selection graphic data 419. In a particular embodiment of this technique, a path describing the outline of the exposed portion of a selected object may be created from the internal display list of the trapping application and used to generate selection graphic data 419. A trapping application may recognize boundaries between objects as distinct objects.

Objects (and/or boundaries of objects) which are selected and which are known to be exposed may be copied from base graphic data 412 directly into selection graphic data 419. This is appropriate for objects in the foreground which are not or cannot be overlapped by other objects. An example of a type of object which would not normally be overlapped by any other object is a trap.

As with other techniques of generating selection graphic data 419, these techniques where only exposed portions of selected objects and/or objects which are known to be exposed are used to generate selection graphic data 419 may comprise assigning highlighting attributes to the objects in selection graphic data 419.

In some embodiments of the invention, highlighting may comprise animating some or all selected objects. Animation may be performed by causing compositing engine 420 to create a plurality of output graphic rasters 422 in which selected objects are highlighted using different patterns and then displaying the plurality of output graphic rasters in rotation.

Certain implementations of the invention comprise computer processors which execute software instructions which cause the processors to perform a method of the invention. For example, one or more processors in a computer may implement the methods of FIG. 3 by executing software instructions in a program memory accessible to the processors. The invention may also be provided in the form of a program product. The program product may comprise any medium which carries a set of computer-readable signals comprising instructions which, when executed by a computer processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links. The computer-readable signals may be compressed or encrypted such that, upon decompression and/or decryption, instructions are made available to a computer processor which can cause the processor to execute a method of the invention.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:

In the above description, the rendering engine obtains base graphic data separately from selection graphic data. In alternative embodiments of the invention, selection graphic data 104 may be included in the base graphic data 102 and the rendering engine may be adapted to generate two sets of raster.

The selection graphic raster and base graphic raster do not need to have the same resolutions. If it is acceptable for the boundaries of highlighting to be off by a small margin of error, then the selection graphic raster could have a lower resolution than the base graphic raster and the compositing engine could be configured to treat each pixel of the selection graphic raster as specifying a highlighting value for a corresponding block of pixels in the base graphic raster (e.g. where the selection graphic raster has half of the resolution of the base graphic raster, each pixel of the selection graphic raster may correspond to a 2×2 block of pixels in the base graphic raster) in the base graphic raster. This permits the selection graphic raster to be made smaller and reduces the time taken to create the selection graphic raster.

The highlighting technique depicted in FIG. 4 and described above depicts a display buffer 424. It is common for a computer system 402 to comprise a display buffer 424, the contents of which are displayed directly on the display 404. FIG. 4 depicts other data storage/data handling devices, which may not be required for the invention. In some embodiments, compositing engine 420 may output directly into display buffer 424, such that no independent data storage/data handling hardware is required for output graphic raster 422. In another possible embodiment, compositing engine 420 may output directly overtop of base graphic raster 411 (or selection graphic raster 413) and then the contents of this buffer may be copied to display buffer 424 for display. While these embodiments do not allow independent simultaneous access to output graphic raster 422 and base graphic raster 411 (or selection graphic raster 413), they help to reduce the required data storage/data handling hardware. Those skilled in the art will appreciate that the highlighting techniques disclosed herein may encompass other well known approaches for reducing the amount of data storage/data handling hardware.

The above description relates mostly to displaying graphics on a computer display. Similar techniques may be used for printing graphics.

Graphics technology involves many other sophisticated techniques which, although applicable in conjunction with this invention, are not described in detail herein. For example, it is a standard practice to render graphic data such that the resulting rasterized data is slightly larger than the display. This allows a user to pan the displayed image by a small amount without re-rendering. It should be understood that this and other similar well known graphics techniques may be applied in conjunction with this invention.

Instead of displaying the base graphic data directly when no objects are being highlighted, a system according to the invention could create a selection graphic raster having only non-highlighting values, create an output graphic raster by compositing a base graphic raster and the selection graphic raster and display the output graphic raster.

Instead of having a compositing engine which patterns areas to be highlighted, a system according to the invention could provide a special rendering engine which patterns areas to be highlighted in the selection graphic raster.

Accordingly, the scope of the invention is to be construed in accordance with the substance defined by the following claims.

What is claimed is:

1. A method for highlighting a selected object on a display, the method comprising:
rasterizing base graphic data to provide a base graphic raster, the base graphic raster comprising at least one graphic object including a selected graphic object to be highlighted;
providing selection graphic data including a graphic object corresponding to the selected graphic object;
rasterizing the selection graphic data to yield a selection graphic raster; and,
compositing the base graphic raster and the selection graphic raster to yield an output graphic raster for display.

2. A method according to claim 1 wherein providing the selection graphic data comprises copying the selected graphic object from the base graphic data.

3. A method according to claim 2 wherein providing the selection graphic data comprises assigning a highlighting attribute to the copied selected graphic object.

4. A method according to claim 3 wherein rasterizing the selection graphic data to yield the selection graphic raster comprises assigning highlighting values only to pixels in the selection graphic raster corresponding to portions of the selected graphic object that are not overlapped by other non-transparent graphic objects.

5. A method according to claim 4 wherein compositing the base graphic raster and the selection graphic raster comprises altering values of pixels from the base graphic raster which correspond to pixels of the selection graphic raster having highlighting values.

6. A method according to claim 2 wherein providing the selection graphic data comprises copying from the base graphic data non-selected objects that overlap the selected graphic object.

7. A method according to claim 6 wherein the highlighting attribute comprises a color attribute.

8. A method according to claim 6 wherein providing the selection graphic data comprises assigning a highlighting attribute to the copied selected graphic object.

9. A method according to claim 8 wherein providing the selection graphic data comprises assigning a blank attribute to the copied non-selected objects.

10. A method according to claim 9 wherein rasterizing the selection graphic data comprises assigning highlighting values to pixels associated with objects having highlighting attributes and assigning non-highlighting values to pixels associated with objects having blank attributes.

11. A method according to claim 10 wherein compositing the base graphic raster and the selection graphic raster comprises altering values of pixels from the base graphic raster which correspond to pixels of the selection graphic raster having highlighting values.

12. A method according to claim 9 wherein the highlighting attribute and the blank attribute each comprise different color attributes.

13. A method according to claim 8 wherein rasterizing the selection graphic data to yield the selection graphic raster comprises assigning highlighting values to pixels corresponding to any objects in the selection graphics data having highlighting attributes.

14. A method according to claim 8 wherein the highlighting attribute comprises a color attribute.

15. A method according to claim 2 wherein rasterizing the selection graphic data to yield the selection graphic raster comprises assigning highlighting values to pixels corresponding to the copied selected graphic object.

16. A method according to claim 15 wherein compositing the base graphic raster and the selection graphic raster comprises altering values of pixels from the base graphic raster which correspond to pixels of the selection graphic raster having highlighting values.

17. A method according to claim 2 comprising simplifying the copied selected graphic object.

18. A method according to claim 17 where simplifying the selected graphic object comprises setting a plurality of color attributes of the selected graphic object to specify one color.

19. A method according to claim 17 wherein an exposed portion of the selected graphic object has an outline and simplifying the selected graphic object comprises replacing the selected graphic object with a shape bounded by the outline.

20. A method according to claim 2 wherein an exposed portion of the selected graphic object has an outline and copying the selected graphic object from the base graphic data comprises replacing the selected graphic object with a shape bounded by the outline.

21. A method according to claim 1 wherein the selection graphic raster comprises highlighting values corresponding to the graphic object corresponding to the selected object and compositing the base graphic raster and the selection graphic raster comprises altering values of pixels from the base graphic raster which correspond to pixels of the selection graphic raster having highlighting values.

22. A method according to claim 21 wherein altering values of pixels from the base graphic raster comprises replacing the values of pixels from the base graphic raster with the highlighting values of corresponding pixels in the selection graphic raster.

23. A method according to claim 21 wherein altering values of pixels from the base graphic raster comprises, for each pixel to be altered, computing a function to modify the value of the pixel to be altered, the function based on at least one of: the value of the pixel to be altered and the highlighting value of the corresponding pixel in the selection graphic raster.

24. A method according to claim 23 wherein the function comprises color inversion of the value of the pixel to be altered.

25. A method according to claim 23 wherein the function comprises performing one of a plurality of available color modification operations and wherein computing the function to modify the value of the pixel to be altered comprises selecting one of the plurality of available color modification operations based on the highlighting value of the corresponding pixel in the selection graphic raster and applying the selected color modification operation to the value of the pixel to be altered.

26. A method according to claim 25 wherein the plurality of color modification operations comprises one or more of:
performing color inversion on the value of the pixel to be altered;
increasing the value of the pixel to be altered by a predetermined amount;
decreasing the value of the pixel to be altered by a predetermined amount; and,
setting the value of the pixel to be altered to a predetermined value.

27. A method according to claim 23 wherein altering values of pixels from the base graphic raster comprises altering values of selected ones of the pixels from the base graphic raster which correspond to pixels of the selection graphic raster having highlighting values.

28. A method according to claim 27 wherein altering values of selected ones of the pixels from the base graphic raster comprises selectively altering values of pixels in accordance with a pattern.

29. A method according to claim 23 wherein compositing the base graphic raster and the selection graphic raster comprises identifying contiguous regions of pixels in the base graphic raster where corresponding pixels in the selection graphic raster have highlighting values.

30. A method according to claim 29 wherein altering values of pixels from the base graphic raster comprises altering values of a pattern of selected pixels in the contiguous regions of pixels in the base graphic raster.

31. A method according to claim 23 wherein altering values of pixels from the base graphic raster comprises altering values of all of the pixels in the base graphic raster which correspond to pixels of the selection graphic raster having highlighting values.

32. A method according to claim 1 wherein providing the selection graphic data comprises replicating the base graphic data and modifying non-selected objects in the replicated base graphic data to have blank attributes.

33. A method according to claim 32 wherein the blank attribute comprises a color attribute.

34. A method according to claim 1 wherein providing the selection graphic data comprises replicating the base graphic data and deleting non-selected objects from the replicated base graphic data.

35. A method according to claim 1 wherein providing the selection graphic data comprises replicating the base graphic data and modifying selected objects in the replicated data to have highlighting attributes.

36. A method according to claim 35 comprising, modifying non-selected objects in the replicated data to have non-highlighting attributes.

37. A method according to claim 35 wherein the highlighting attribute and the blank attribute each comprise color attributes.

38. A method according to claim 1 wherein the selection graphic data and the base graphic data each comprise a file having a file format and the selection graphic data and the base graphic data have the same file format.

39. A method according to claim 1 wherein rasterizing the base graphic data is performed by a rendering engine and rasterizing the selection graphic data is also performed by the rendering engine.

40. A method according to claim 1 wherein compositing the base graphic raster and the selection graphic raster comprises identifying contiguous regions of pixels in the base graphic raster where corresponding pixels in the selection graphic raster have highlighting values.

41. A method according to claim 40 wherein compositing the base graphic raster and the selection graphic raster comprises altering values of a pattern of selected pixels in the contiguous regions of pixels from the base graphic raster.

42. A method according to claim 1 wherein the graphic objects in the base graphic data and the selection graphic data are elements of a graphic description language file or stream.

43. A method according to claim 42 wherein the file or stream comprises tags located to delineate the graphic objects.

44. A method according to claim 1 comprising subsequently removing highlighting by compositing the selection graphic raster with the graphic raster for display.

45. A method according to claim 1 comprising subsequently causing the highlighting to change periodically in time by periodically compositing the selection graphic raster with the output graphic raster.

46. A method according to claim 1 wherein the base graphic raster includes a plurality of selected graphic objects to be highlighted, the plurality of selected graphic objects including at least graphic objects of first and second types and wherein providing the selection graphic data comprises providing in the selection graphic data an object corresponding to each of the plurality of selected graphic objects and assigning a highlighting attribute to each of the objects, the method comprising assigning different highlighting attributes to objects corresponding to graphic objects of the first and second types.

47. A method according to claim 46 wherein providing in the selection graphic data an object corresponding to each of the plurality of selected graphic objects comprises copying the plurality of selected graphic objects from the base graphic data.

48. A method according to claim 47 wherein copying the plurality of selected graphic objects comprises simplifying one or more of the plurality of selected graphic objects.

49. A method according to claim 2 wherein rasterizing the selection graphic data comprises assigning highlighting values to pixels in an area of the selection graphic raster corresponding to the copied selected graphic object and compositing the base graphic raster and the selection graphic raster comprises patterning areas within the output graphic raster corresponding to the area of the selection graphic raster.

50. A method according to claim 49 comprising creating a plurality of output graphic rasters, for each of the plurality of output graphic rasters differently patterning the areas within the output graphic raster, and displaying the plurality of output graphic rasters in rotation.

51. A method according to claim 1 wherein the base graphic raster has a higher resolution than the selection graphic raster.

52. A system for highlighting a selected object on a display, the system comprising a data processing system executing instructions which cause the data processing system to:
rasterize base graphic data to provide a base graphic raster, the base graphic raster comprising at least one graphic object including a selected graphic object to be highlighted;
provide selection graphic data including a graphic object corresponding to the selected graphic object;
rasterize the selection graphic data to yield a selection graphic raster; and,
composite the base graphic raster and the selection graphic raster to yield an output graphic raster for display.

53. Apparatus for displaying a raster image with areas corresponding to selected objects highlighted, the apparatus comprising:
a user interface configured to permit selection of one or more objects of base graphic data comprising a plurality of graphic objects;
means for producing a selection graphic data wherein selected objects are represented by a highlighting attribute;
a rendering engine configured to rasterize the base graphic data to yield a base graphic raster and configured to rasterize the selection graphic data to yield a selection graphic raster; and,
a compositing engine configured to composite the base graphic raster and the selection graphic raster to yield a graphic raster for display.
